(19) United States
(12) Patent Application Publication
(10) Pub. No.: US 2018/0096296 A1
(43) Pub. Date: Apr. 5, 2018

(54) METHOD AND SYSTEM FOR DISTRIBUTING ON DEMAND ADDRESS-LESS GOODS

(71) Applicant: MANGATA, INC., New York, NY (US)

(72) Inventors: Andrei Liviu PAPANCEA, New York, NY (US); Vlad Gabriel PAPANCEA, New York, NY (US)

(21) Appl. No.: 15/703,492

(22) Filed: Sep. 13, 2017

Related U.S. Application Data
(60) Provisional application No. 62/404,654, filed on Oct. 5, 2016.

(51) Int. Cl. G06Q 10/08

(52) U.S. Cl. CPC G06Q 10/0833; G06Q 10/087

(57) ABSTRACT

A method for distributing on-demand items includes receiving an input, by a server system, from a sender device. The input includes at least an order for an item to be sent to a recipient and at least one identifier of the recipient. The method includes electronically sending a notification regarding the order to a recipient device. the method includes facilitating a verification of the at least one identifier of the recipient based at least on a successful communication with the recipient device using the at least one identifier. The method includes receiving delivery information from the recipient device upon successful verification of the at least one identifier of the recipient received from the sender device. Thereafter, the method includes enabling delivery of the order to the recipient based on the delivery information. Thereafter, the method includes electronically notifying the sender device of a receipt of the order by the recipient.

### TECHNICAL FIELD

Embodiments of the disclosure relate generally to gift sending and, more particularly, to a method and system for distributing on-demand address-less goods to a recipient.

### BACKGROUND

Goods such as gifts are sent to somebody to show them regards or gratitude, convey them good wishes or congratulate them on special occasions. Gifts are a way to express love, friendship, gratitude and celebrations. A gift is given to someone without expectation of payment. Traditionally, gifts are handed over in person to the recipient. However, with advent of technology, several websites/apps help in sending gifts to the recipients without the need for the senders and the recipients to be together to physically hand over the gifts to the recipients.

Many conventional apps and websites provide a user-friendly platform that makes it easier to send items to recipients' address. For instance, apps such as, “Giftagram.com” and “Amazon Prime Now” enable sending items to an address of a recipient. However, there are several drawbacks in the existing apps, especially in specifying a preferred time and day of getting the item/gift delivered at the recipient's address. Hence, synchronizing with the recipients' schedule becomes difficult with current implementation of the existing apps.

Furthermore, at times, the gift sender may not be aware of or may not remember the recipient's address while placing the order. Most of the existing apps mandatorily require the recipients' address to be entered by the sender before allowing the sender to pay and check out of the app. The sender either has to ask for the address to the recipient or to somebody who knows the address of the recipient, which is a tedious task because the sender may not get a response immediately, thereby delaying the order placement. Existing apps with their current implementation burden the gift sender to remember the recipients' address, which is not desirable.

In light of the above discussion, there appears to be a need for distributing items meeting the recipient's schedule without requiring a sender to provide the recipient's address.

### SUMMARY

Various embodiments of the present disclosure provide systems and methods for distributing on-demand items to a recipient.

An embodiment provides a method for distributing on-demand items includes receiving an input, by a server system, from a sender device. The input includes at least an order for an item to be sent to a recipient and at least one identifier of the recipient. The method includes electronically sending a notification regarding the order to a recipient device associated with the recipient. Further, the method includes facilitating a verification of at least one identifier of the recipient based at least on a successful communication with the recipient device using the at least one identifier. Furthermore, the method includes receiving delivery information from the recipient device upon successful verification of the at least one identifier of the recipient received from the sender device. Thereafter, the method includes enabling delivery of the order to the recipient based on the delivery information of the recipient. Thereafter, the method includes electronically notifying the sender device of a receipt of the order by the recipient.

Another embodiment provides a server system for distributing on-demand items to a recipient. The server system includes a memory storing instructions, and at least one processor configured to execute the stored instructions to cause the server system to at least perform receiving an input from a sender device. The input includes at least an order for an item to be sent to a recipient and at least one identifier of the recipient. The server system is further caused to electronically send a notification regarding the order to a recipient device associated with the recipient. Further, the server system is caused to facilitate a verification of the at least one identifier of the recipient based at least on a successful communication with the recipient device using the at least one identifier. Furthermore, the server system is caused to receive delivery information from the recipient device upon successful verification of the at least one identifier of the recipient received from the sender device. Thereafter, the server system is caused to enable delivery of the order to the recipient based on the delivery information of the recipient. Thereafter, the server system is caused to electronically notify the sender device of a receipt of the order by the recipient.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an environment in which a system, for distributing on-demand items to a recipient, is deployed, related to at least some embodiments;

FIG. 2 is a simplified block diagram of a sender device and a server system including an application for facilitating distribution of on-demand items to a recipient;

FIG. 3A is a simplified illustration of a user interface provided by the application available at the sender device facilitating selection of items by the sender to be sent to the recipient;

FIG. 3B is a simplified illustration of a user interface provided by the application available at the sender device facilitating display of a selected item to be sent to the recipient;

FIG. 3C is a simplified illustration of a user interface provided by the application available at the sender device facilitating an actionable icon that enables a command to wrap up the order to be sent to the recipient;

FIG. 4A is a simplified illustration of a user interface provided by the application displaying a list of contacts including the recipient;

FIG. 4B is a simplified illustration of a user interface provided by the application enabling the sender to place an order;

FIG. 4C is a simplified illustration of a user interface provided by the application available at the sender device displaying a summary of the order during checkout by the sender;

FIG. 4D is a simplified illustration of a user interface provided by the application available at the sender device notifying the sender about status of the order;

FIG. 5A is a simplified illustration of a user interface available at the recipient device notifying the recipient about the order;

FIG. 5B is a simplified illustration of a user interface available at the recipient device facilitating verification of the recipient/recipient device;

FIG. 5C is another illustration of a user interface available at the recipient device facilitating verification of the recipient/recipient device;

FIGS. 5D-5E are illustrations of user interfaces available at the recipient device enabling the recipient to provide an address for the order delivery;

FIG. 5F is an illustration of a user interface available at the recipient device enabling the recipient to provide a preferred time and date for the order delivery;

FIG. 5G is an illustration of a user interface available at the recipient device displaying a delivery summary using the information provided by the recipient;

FIG. 6A is an illustration of a user interface available at the merchant device displaying the order summary to the merchant and enabling the merchant to accept or decline the order;

FIG. 6B is an illustration of a user interface available at the merchant device enabling the merchant to select a reason for declining the order;

FIG. 6C-6E are illustrations of user interfaces available at the merchant device displaying that status of order;

FIG. 7A is a flowchart illustrating a workflow between the sender device, the server system and the recipient device, for distributing on demand address-less items, in accordance with an example embodiment;

FIG. 7B is another flowchart illustrating a workflow between the server system, the merchant device and the delivery service entity device for distributing on demand address-less items, in accordance with an example embodiment

FIG. 8 is a schematic representation of the workflow, according to the embodiments as disclosed herein;

FIG. 9 is a flowchart illustrating a method of distributing on demand address-less items, in accordance with an example embodiment;

FIG. 10 is a block diagram of a device which may be an example of the sender device, the recipient device, the merchant device and the delivery service entity device; and

FIG. 11 is a simplified block diagram of the server system, in accordance with one embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Overview

Various example embodiments of the present disclosure provide methods and systems for distributing on-demand items to a recipient.

Embodiments provide a system and methods for distributing on-demand items. The items may be gifts sent by a sender to a recipient. The system includes a sender device communicating with a server system through an application. The application and its components rest on the server system and are made available at the sender device. The system further includes a recipient device and a merchant device operatively communicating with the server system by means of communication networks. The application and its components are further made available at the recipient device and the merchant device. The application allows the sender device to provide an input comprising at least an order for an item to be sent to a recipient and at least one identifier of the recipient. The identifier may include one or more of the recipient's name, phone number and the email address associated with the recipient. The application further allows the sender device to provide as input, a time and date at which the server system should send the notification to the recipient device. The application facilitates the sender device to conclude a payment for the order placed and subsequently enables checking out of the application.

The server system sends notification to the recipient device about the order at the time and date specified by the sender. The notification includes a message with instructions on how to claim gift item/order. The server system further facilitates verification of the identifiers of the recipient received from the sender device based on at least a successful communication with the recipient device. The recipient may be instructed to enter at least one of the identifiers as a first step of verification. Upon successfully entering the at least one of the identifiers, the recipient device may receive an auto generated code, which has to be sent to the server system. Sending the correct auto generated code to the server system authenticates the recipient device. Upon successful authentication, the recipient device may be allowed to provide the delivery information including a shipping address and date and time of delivery.

The application includes a scheduling module which is responsible for notifying the recipient about the order at the time and date specified by the sender while placing the order. The scheduling module is responsible for sending notifications to the sender device regarding the claim of the order by the recipient. The scheduling module constantly detects for due notifications received from the server system and regularly checks for due orders for delivery. Scheduling module detects one or more orders that are due to be picked up from merchants. The scheduling module further engages a delivery service entity and provides pickup and delivery instructions to the delivery service entity. Alternatively or additionally, the scheduling module enables the merchant to engage the delivery service entity, with pickup and delivery instructions. The scheduling module is responsible for sending notifications to the recipient device and the sender device regarding the status of the order and delivery.

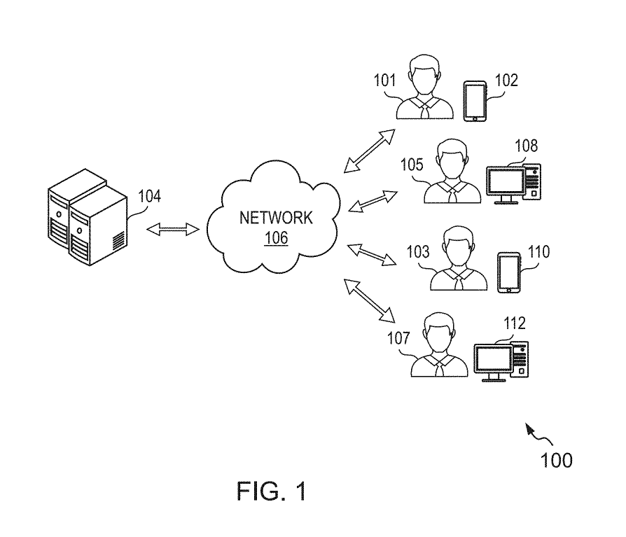

FIG. 1 is a simplified illustration of an environment in which a system 100, for distributing on-demand items, is deployed, in accordance with some embodiments as disclosed herein. The system 100 includes a user device 102 and a server system 104. Examples of the user device 102 include, but are not limited to, a personal computer (PC), a tablet device, a personal digital assistant (PDA), a smart phone and a laptop. The user device 102 may be a device that a gift sender (hereinafter referred to as sender) operates to order and send gifts to a recipient. The system 100 further includes a merchant device 108 and a recipient device 110. User device 102 may also be referred to as sender device 102 throughout the disclosure.

A sender 101 is one who desires to gift an item to a recipient without payment. An item/good/gift may be defined as a commodity given to a recipient 103 (person/group/organization) without the expectation of a payment. For instance, the sender 101 may want to gift the recipient 103 for his/her birthday. The terms “item”, “good” and “gift” are interchangeably used throughout the disclosure and may constitute an “order” within the scope of the disclosure.

The sender 101 may include an individual or a group of individuals or an entity. The recipient 103 is one who receives the item. The recipient 103 may include, within the scope of its meaning, an individual or a group of individuals or an entity.

The server system 104 may be a remote virtual server such as a cloud server. The server system 104 may be a third party applications server that collects information on commodities sold by different merchants and enables display of such commodities on a single platform such as a user interface facilitated by an application. Alternatively, the server system 104 may be hosted by a merchant from whom the sender may buy gifts to be sent to the recipient.

The sender device 102 further includes a communication module that enables communication with other devices, such as the server system 104 via a communication network similar to the network 106. The network 106 may include any suitable number or arrangement of interconnected networks including both wired and wireless networks. By way of example, a wireless communication network link over which mobile devices communicate may utilize a cellular-based communication infrastructure. The communication infrastructure includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link may further include, or alternately include, a variety of communication channels and networks such as WLAN/Wi-Fi, WiMAX, Wide Area Networks (WANs), and Bluetooth.

The server system 104 facilitates the sender device 102 to communicate data including one or more identifiers corresponding to the recipient 103. The identifiers may include a name, a phone number or an email address with which the recipient 103 may be identified. Further, data corresponding to a date and preferably a time on which a notification should be sent to a recipient device (see 110) is communicated by the sender device to the server system 104. Subsequently, the sender 101 places the order for the gift/item. The system 100 further facilitates the sender 101 to conclude a payment through the sender device 102.

The system 100 includes the merchant device 108 associated with a merchant 105, who is a wholesaler/retailer who buys and sells commodities for profit. Examples of the merchant device 108 include, but are not limited to, personal computer (PC), tablet device, personal digital assistant (PDA), smart phone and laptop. The merchant device 108 may be similar to the sender device 102. The merchant 105 operates the corresponding merchant device 108 in order to check due orders and engage delivery service entities to deliver orders to the recipients 103. The server system 104 may communicate with the merchant device 108 via a network similar to network 106.

The environment includes a plurality of merchants 105 and corresponding merchant devices 108, where each merchant 105 may be associated with one or more items/orders. Once the sender 101 claims the order, the server system 104 is configured to notify the merchant device 108 corresponding to the merchant 105 with whom the item, within the order, is associated.

Examples of the recipient device 110 include, but are not limited to, personal computer (PC), tablet device, personal digital assistant (PDA), smart phone and laptop. The recipient device 110 may be similar to the sender device 102. A recipient 103 operates the corresponding recipient device 110 in order to claim the order and get it delivered at a preferred time of a preferred day at a preferred address. The server system 104 may communicate with the recipient device 110 via a network similar to network 106.

In some embodiments, the system 100 further facilitates a delivery service entity device 112 associated with a delivery service entity 107. The delivery service entity 107 may be a logistics entity or a transportation entity or a shipping entity that is responsible for transportation of items from a merchant location (warehouse) to an address of a recipient (e.g., recipient 103). Examples of the delivery service entity device 112 include, but are not limited to, personal computer (PC), tablet device, personal digital assistant (PDA), smart phone and laptop. The server system 104 may communicate with the delivery service entity device 112 via a network such as the network 106.

In an alternate or additional embodiment, one or more merchants 105 may facilitate delivery services of their own. It shall be noted that the delivery service entity 107 may not be required to communicate with the server system 104. The merchant 105 and the delivery service entity 107 may communicate using an application specifically developed by the merchant 105 or a third party application developer on behalf of the merchant 105. Further, the merchants 105 may communicate with the delivery service entities 107 via a network similar to network 106.

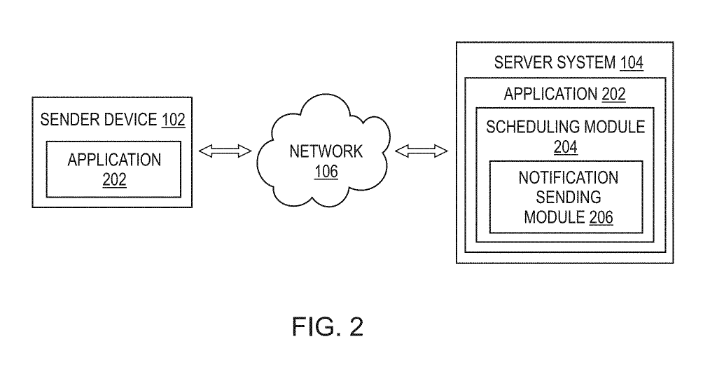

FIG. 2 is a simplified block diagram of the sender device 102 and the server system 104 including an application 202 for facilitating distribution of on-demand items to a recipient. In an example embodiment, the user device 102 or a processor of the user device 102 is equipped with the application 202 installed therein. The application 202 facilitates sending or distributing goods to the recipients 103 by the sender 101. The application 202 and its components rest in the server system 104 within a storage unit/interface of the server system 104. The application 202 is a set of computer executable codes that causes a processor of the server system 104 to perform one or more methods disclosed herein. The application 202 is managed by the server system 104, and it can be readily made available at any compatible user device 102 that can communicate with the application 202.

Instances of the set of computer executable codes may be stored in a memory/storage of the user device 102, wherein the computer executable codes are executed by a processor of the user device 102 to perform one or more methods as disclosed herein. The application 202 may facilitate one or more buttons or actionable icons, selection (by a pressing/click or touch) of which enables display of one or more pages at a user interface (UI) of the sender device 102.

The merchant device 108 and recipient device 110 may also be equipped with the application 202 installed therein. However, it may be optional for the merchant device 108, the recipient device 110 to have the application 202 installed. In case the merchant device 108 and the recipient device 110 do not have the application 202 installed therein, the merchant device 108 and the recipient device 110 may be facilitated with a web browser that can enable access of the application 202. The web browser further facilitates one or more buttons or actionable icons, selection (e.g., by a pressing/click or touch) of which redirects to one or more html pages.

The application 202 may be a mobile application or a web application. The application 202 may be designed by a third party entity to facilitate a platform for buying and sending gifts to recipients by the senders 101. Alternatively, the application 202 may be designed by a merchant (e.g. merchant 105) to facilitate a platform for buying and sending items to the recipients 103 by the senders 101, wherein the items are specific to the merchant 105.

The application 202 may include a scheduling module 204. Specifically, the scheduling module 204 is configured with a notification sending module 206. The notification sending module 206 is configured to send push notifications, emails, and/or text messages to devices such as the user device 102, the merchant device 108 and the recipient device 110. The scheduling module 204 supports batch push to send push notifications. The scheduling module 204 may use a queue, cron jobs, notifications, and micro-services to mass-send all the notifications.

The scheduling module 204 is configured to send notifications to the sender device 102, regarding the claim of items by the recipient 103. Further, scheduling module 204 is configured to send notifications to the sender device 102, regarding the delivery of the item(s) to the recipient 103. The application 202 may utilize the scheduling module 204 to constantly detect due notifications and due orders for delivery to be sent to merchant device 108. The scheduling module 204 is responsible for communicating, to the recipient device 110, a notification on the date and time as specified by the sender 101 while ordering the gift/item to be delivered to the recipient 103. Further, the scheduling module 204 is responsible for communicating to the recipient device 110, a message with instructions on how to claim the gift. The scheduling module 204 is configured to notify the delivery service entity 107 to pick up the order from a warehouse of the merchant 105. The scheduling module 204 is further configured to provide instructions to the delivery service entity 107 regarding the pickup and delivery.

Referring to the following embodiments and the figures, the data flow/communication between the sender device 102, the server system 104, the merchant device 108 and the recipient device 110 of the system 100 for distributing on demand address-less items is illustrated.

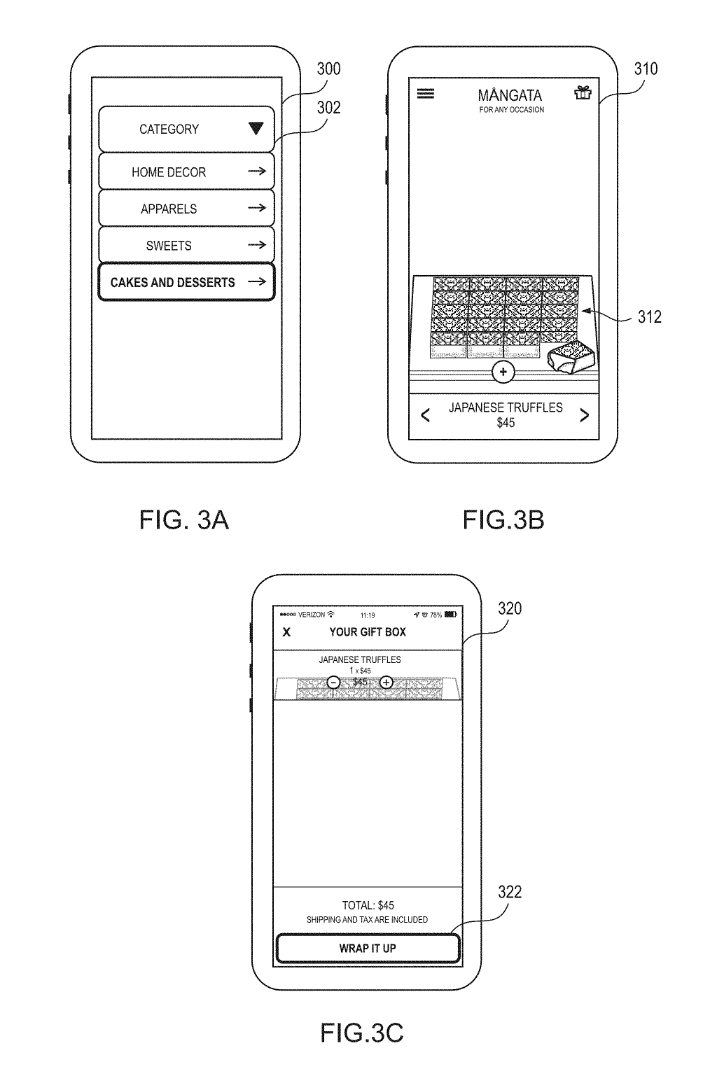

FIG. 3A is a simplified schematic illustration of a user interface 300 of the application 202, available at the sender device 102, for facilitating selection of items by the sender 101 to be sent to the recipient 103. Among other information, the user interface 300 allows the sender 101 to click or tap on an actionable icon 302 that displays category of items. Selection of icon 302, may trigger a drop down menu as seen in FIG. 3A. The icon 302 may include a plurality of categories into which items may be classified or grouped. The categories, for example may be home decor, apparels, jewellery, shoes, watches, books, sweet and savouries, cakes and desserts, flower bouquets etc. In the exemplary representation of FIG. 3A, some categories such as ‘Home decor’, ‘apparels’, ‘Sweet’ and ‘cakes and desserts’ are shown for example purposes. Upon selection of at least one of the categories from the drop down menu, the user interface 300 provides a display (not shown) of all the items available with the server system 104 grouped within the selected category. In an example, the user selects a category titled “cakes and desserts”. Upon selection of “cakes and desserts”, the user interface 300 provides a display (not shown) of all the items indicative of cakes and/or desserts. Each item may be associated with a merchant. Information corresponding to the merchant may also be displayed below each item. Further, the corresponding price (see FIG. 3B) associated with each item may be displayed below the item display. It shall be noted that the user interface 300 is not limited to the example embodiment disclosed herein.

FIG. 3B is an illustration of a user interface 310 of the application 202, available at the sender device 102, facilitating selection of items by the sender 101 to be sent to the recipient 103. The sender 101 accesses the application 202 to browse through the categories of items. The sender 101 can select at least one item for order from at least one category. In an example, the sender 101 selects an item from a category titled “cakes and desserts” facilitated by the actionable icon 302. Upon selection of “cakes and desserts”, the user interface 310 provides a display 312 of an item, “Japanese truffles”. The user interface 310 further displays a price (e.g. $ 45) associated with the item, “Japanese truffles”. Upon selecting “Japanese truffles” on the display 312, the application 202 directs the sender 101 to a subsequent user interface 320 as seen in FIG. 3C. The user interface 320 displays the summary of the item including the name of the item (“Japanese truffles”) price ($ 45, including shipping charges and taxes), the quantity (1 no.). The user interface 320 further includes an actionable icon 322 which enables the sender 101 to input a command for example to wrap up the order.

It shall be noted that the user interfaces 300, 310, and 320, are interfaces displayed at a sender device 102 when the server system 104 communicates with the sender device 102, and they represent only one example of interfaces, and it should not be considered limiting to the scope of the disclosure.

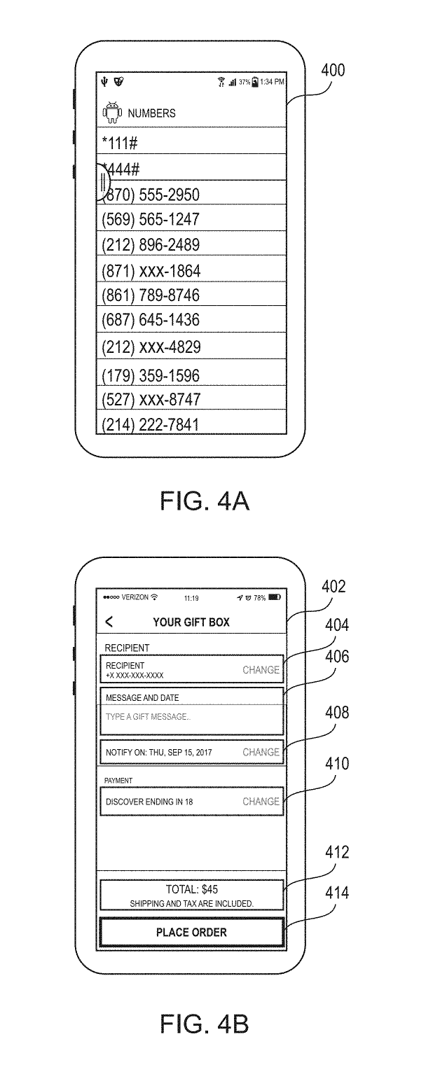

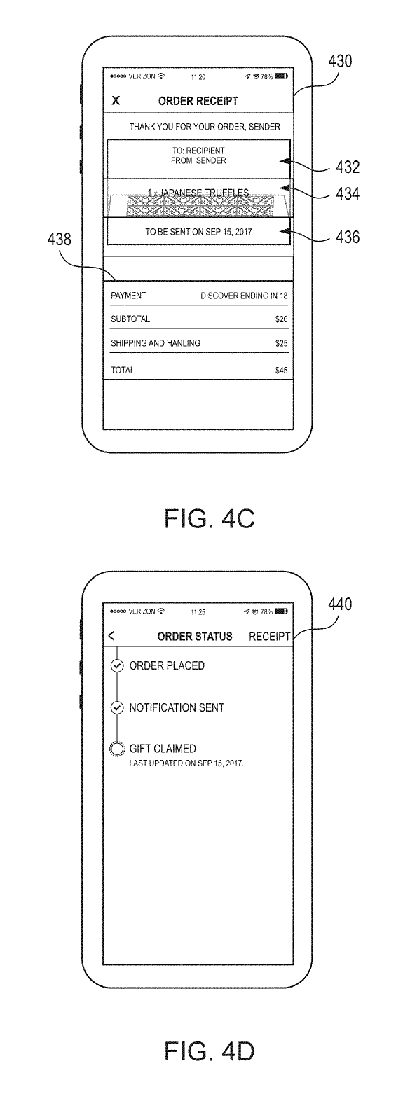

FIG. 4A is an illustration of a user interface 400 of the application 202 displaying a list of contacts corresponding to different people including the recipient 103 available at the sender device 102. User interface 400 allows selection of the recipient 103 to whom the order is to be sent. The sender 101 selects at least one identifier corresponding to a recipient selected from the list of contacts at the sender device 102. The identifier may include one or more of a name, a phone number and an email address of the recipient.

The application 202 may be capable of accessing the list of contacts at the sender device 102, such that when the item for order is selected, the application 202 displays, to the sender 101, the list of contacts from which the sender 101 can select one or more of the name, phone number and email address of the recipient(s).

Referring to FIG. 4B, upon selecting of the identifier corresponding to a recipient 103 from a list of contacts available at the sender device 102, the application 202 displays a user interface 402, which comprises one or more fields. The user interface 402 includes a field 404 which may include pre selected identifiers associated with the recipient 103. The field 404 may be auto filled as the identifier corresponding to the recipient 103 is selected at user interface 400. The identifier may include the recipient's name and a phone number (e.g. “Recipient 1, +1 XXX-XXX-XXXX). The application 202 may also allow the sender 101 to manually enter or input an identifier associated with the recipient 103 at field 404. The application 202 may facilitate a field 406, where the sender 101 may provide a message or a note (e.g. “Happy Birthday”, “Happy Anniversary” “Congratulations”, “Thank You” etc.) to the recipient 103. The application 202 may facilitate a field 408, where the sender 101 may provide a date and time at which the recipient is to be notified regarding the order/gift.

The application 202 may further facilitate a field 410, which may be optional. The field 410 allows the sender 101 to input at least a portion of information (e.g. card number) associated with a payment card (credit card/debit card). Alternatively or additionally, the field 408 may be auto filled with information (e.g. card number) associated with a payment card collected from third party platforms, where the sender 101 may have concluded a transaction using the same payment card in the past. Alternatively or additionally, the field 410 may include a drop down menu which may display a list of payment cards associated with the sender 101, which, the sender 101 may have saved within the application 202 while conducting a transaction using application 202 in the past. The Field 412 displays a total price inclusive of shipping charges and taxes.

The user interface 402 includes an actionable icon 414 defining a command “place order”, for enabling the sender 101 to make the payment for the selected item in the order. Selection of the actionable icon 414 may open a page (not shown) that enables the sender 101 to select a mode of payment, such as, net banking, credit card, debit card, wallet (applications available from third party), vouchers or coupons, etc. Further, selection of one of these above options indicating the mode of payment from the actionable icon 414 may redirect the sender 101 to a payment gateway (not shown), where the sender 101 may select payment details, such as payment card type, card number, payment card issuing bank, which subsequently redirects the sender 101 to the associated bank's website (not shown) to complete the transaction.

FIG. 4C is a user interface 430 of the application 202 available at the sender device 102 displaying a summary of the order during checkout by the sender. Once the order is placed and a payment is completed, the application 202 displays the user interface 430, which includes a field 432 displaying at least one identifier associated with the recipient (e.g. recipient's name, “Recipient 1”) and the sender's information (e.g. sender's name, “Sender”). The user interface 430 further displays the summary of the order at fields 434 and 436. The field 434 may include information associated with the item such as the merchant information and attributes related with the item, such as, color, size quantity etc, wherever applicable. Further, the field 436 may include the date and time, specified by the sender 101, at which the recipient is to be notified of the order. The user interface 430 further displays summary of the payment related information including the payment card number, shipping charges, taxes and total price of the order, at a field 438.

FIG. 4D is a simplified representation of a user interface 440 of the application 202 available at the sender device 102 displaying a status of the order at one or more stages of the order delivery at the sender device 102. The user interface 440 displays texts indicating the status of the order. As an example, the texts may include status such as, “order placed”, “notification sent”, “gift claimed” etc. An icon (“✓”), such as a check mark indicating successful completion of the task (e.g. “order placed”, “notification sent”, “gift claimed”) may be provided next to the texts.

It shall be noted that the user interfaces 400, 402, 430 and 440, are interfaces displayed at a sender device 102 when the server system 104 communicates with the sender device 102.

It shall further be noted that the sender 101 is notified when the recipient 103 has declined the order. The application 202 facilitates storing the fund paid by the sender 101 against the order, in form of an escrow if the recipient 103 does not claim the order, which is refunded to the sender 101 within a predefined duration of time. Alternatively or additionally, the fund paid by the sender 101 against the order may be issued as store credit if the recipient 103 declines the order.

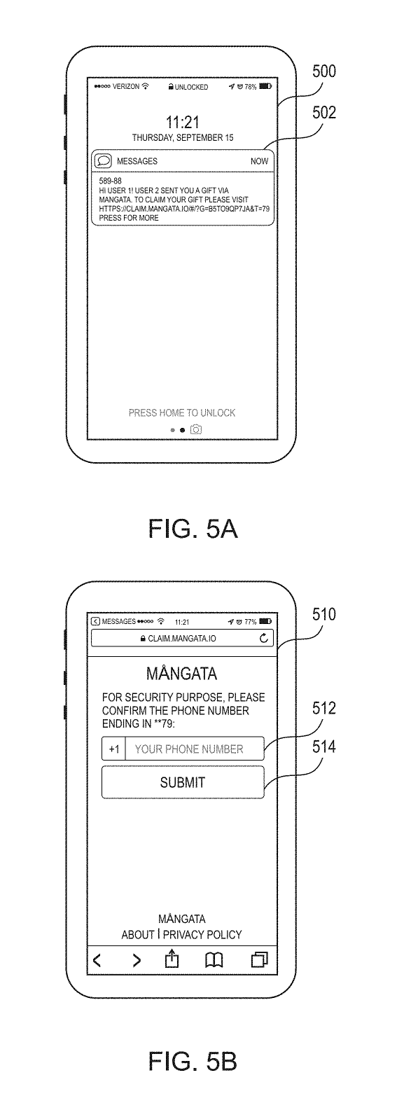

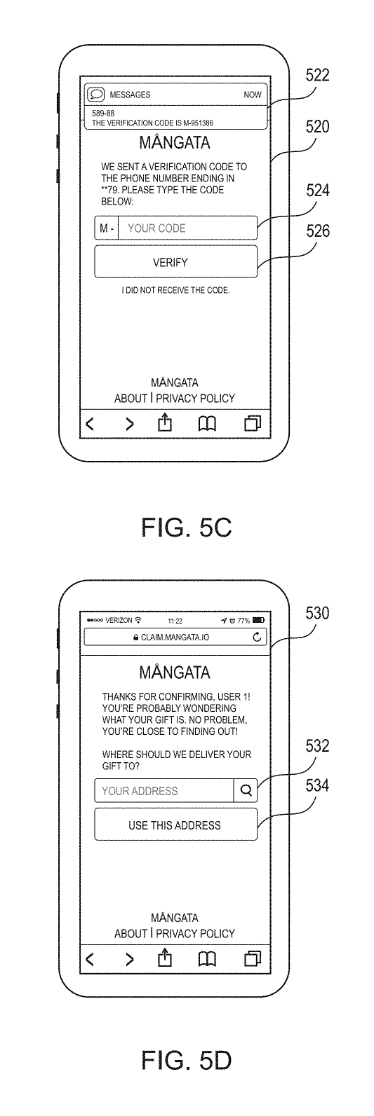

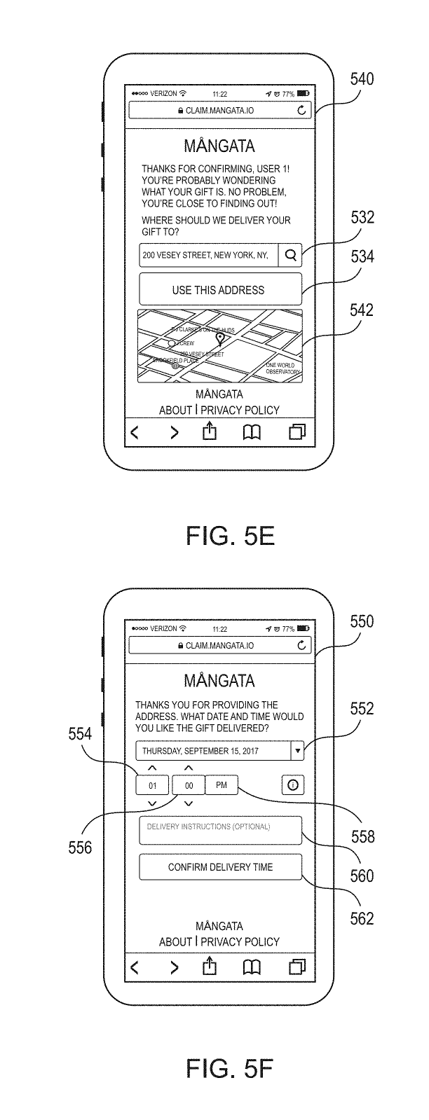

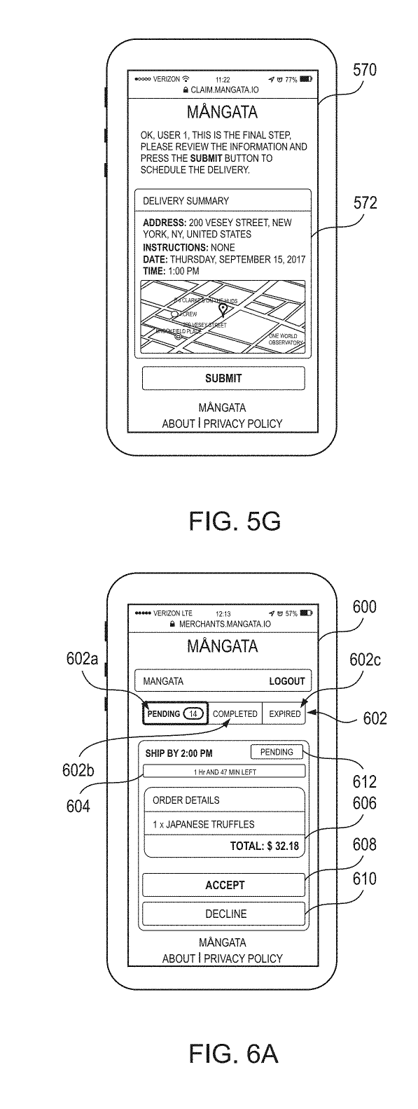

The scheduling module 204 is responsible for communicating, to the recipient device 110, a notification on the date and time as specified by the sender 101 while ordering the gift/item to be delivered to the recipient 103. Further, the scheduling module 204 is responsible for communicating, to the recipient device 110, a message with instructions on how to claim gift items. The recipient 104 is requested for a verification process, which on success entitles the recipient 103 with the good/gift/item. The application 202 facilitates verification of the identifier of the recipient based at least on successful communication with the recipient device 110. As an example, the application 202 may send an auto generated code such as a “one time password” (OTP) or a “PIN” to at least one of the identifiers (phone number or email address) of the recipient for authentication of the recipient 103/recipient device 110. The application 202 may provide option for a recipient 103 to enter the auto generated code. Upon successful authentication of the recipient 103 (i.e. the recipient device 110), the recipient 103 is allowed to specify delivery information including a shipping address, a date and a time for the delivery of the item, among other information. Additional delivery instructions may also be provided by the recipient 103. Upon delivery, the scheduling module 204 notifies the sender 101 regarding the receipt of the order and that the order is “complete” (FIG. 5D).

In an alternate or additional embodiment, for recipient devices 110 that may not be equipped with the application 202 installed therein, a text message or an email is sent to the recipient device 110 on the phone number or the email address provided by the sender 101. As an example, the text message or email may include a link and the recipient 103 is instructed to click on the link to be redirected to a page (e.g. html page) in order to claim the gift. On the page, the recipient 103 may be instructed to input at least one identifier (phone number or email address). The identifier is matched against the identifiers provided by the sender at the time of ordering. If the identifier is successfully matched, an auto-generated code is sent to the recipient device 110. The recipient 103 is instructed to enter the auto-generated code at a field provided in the html page. If the entered code is correct, the recipient 103 is prompted to enter the delivery address/shipping address at a field provided in the html page. This step may use third-party address auto complete services, to enhance the user experience and speed up the process. The recipient 103 is further prompted to pick a date and time for the delivery, as well as provide additional delivery instructions. The delivery date/time may vary depending on merchant time preparation requirements, legal holidays, and other similar events (e.g. cake takes 6 hours to complete). The recipient 103 is further prompted to confirm all the information they entered. The recipient 103 is instructed to submit all information and subsequently confirm the delivery.

FIGS. 5A-5G are illustrations of user interfaces 500, 510, 520, 530, 540, 550 and 570 for facilitating a recipient device 110 to claim items sent by the sender. It shall be noted that the illustrations of the FIGS. 5A-5G are in support of the embodiment(s) where the recipient device 110 is not equipped with the application 202 installed therein. User interfaces 500, 510, 520, 530, 540, 550 and 570 in this scenario may be html pages of the web application for distributing on-demand address-less goods. Further, it shall be noted that the user interfaces 500, 510, 520, 530, 540, 550 and 570 are interfaces displayed at a recipient device 110 when the server system 104 communicates with the recipient device 110.

Referring to FIG. 5A, an example user interface 500 displays a text message 502 (notification) received at the recipient device 110 regarding the order. The text message includes a name of the sender. The text message comprises a link that will redirect the recipient 103 to user interfaces 510, 520, 530, 540, 550 and 570 subsequently one after the other and facilitates the recipient 103 to claim the gift. Upon clicking the link provided in the text message at the user interface 500, a user interface 510 is displayed as seen in FIG. 5B. The user interface 510 prompts the recipient 103 to input at least one identifier (phone number or email address) at a field 512 which is specified by the sender 101. An actionable icon 514 allows the recipient 103 to submit the identifier. Upon successful verification of the identifier, the recipient device 110 receives a text message 522 including an auto generated code, such as a “one time password” (OTP) or a “PIN” at a user interface 520 as seen in FIG. 5C. Upon successfully verifying the auto generated code, the recipient 103/recipient device 110, is authenticated. The user interface 520 further displays a field 524 where the recipient is prompted to enter the auto generated code. Selection of a actionable icon 526 enables the recipient 103 to verify the auto generated code. Verifying the auto generated code may include sending the code to the server system 104 by the sender device 102, where it is checked whether the auto generated code is valid or not.

It shall be noted that, the server system 104 further facilitates the recipient device 110 with a choice (not shown) to accept or decline an order.

Referring to FIGS. 5D-5E, user interfaces 530 and 540 are displayed upon successful verification of the auto generated code. A field 532 of the user interface 530 allows the recipient 103 to enter a physical address associated with the recipient 103. The physical address may be an address where the recipient 103 wishes to get the item/gift delivered. The field 532 is a searchable field, where the recipient 103 may input one or more letters or words indicating the address and receives suggestions of addresses to select from (shown in FIG. 5E, user interface 540). As an example, the physical address as an example may be “200, Vesey Street, New York, N.Y., United States” displayed at the field 532. An actionable icon 534 allows the recipient 103 to use or submit an address entered in the field 532. The user interface 540 includes a pin location on a map 542, which represents the physical address entered in the field 532 of user interface 530.

Referring to FIG. 5F, a user interface 550 is displayed. The user interface 550 includes one or more fields. A field 552 enables the recipient 103 to enter a date on which the recipient 103 wishes to receive the order. The field 552 may be a drop down calendar menu including date, month and year. The recipient 103 can select the date, the month and the year from the drop down calendar menu of the field 552. Further, fields 554 and 556 allow the recipient 103 to select a time in terms of hours and minutes. The field 558 allows the recipients to specify “AM” or “PM” with the time. A field 560 enables the recipient to enter texts indicating delivery instructions. The field 560 may be optional and the recipient may choose to not provide or enter any delivery instructions. Examples of delivery instructions may include instructions such as, “do not ring the bell”, “tell the doorman to call up”, “first apartment at the left on the fifth floor”, etc. An actionable icon 562 allows the recipient 103 to confirm the information related to delivery time entered by the recipient 103 at fields 552, 554, 556 and 558.

In an embodiment, the application 202 may send notification to the sender device 102 regarding the notification being sent at the recipient device 110. Further, upon entering an address and preferred date and time for receiving order by the recipient 103, the application 202 may send notification to the sender device 102 about the recipient 103 claiming the order.

Referring to FIG. 5G, a user interface 570 is displayed. The user interface 570 includes a delivery summary of the information entered by the recipient at FIGS. 5E and 5F at user interfaces 540 and 550, respectively. The delivery summary 572 may include the recipient's address and the time and date of delivery entered by the recipient at user interfaces 540 and 550. An actionable icon 574 enables the recipient 103 to submit the information related to delivery time and address entered by the recipient 103.

The scheduling module 204 detects for due notifications and regularly checks for due orders for delivery. The scheduling module 204 further detects that one or more orders are due to be picked up from merchants. If due orders are present then, the orders are sent to the merchant device 108 at the optimal time to avoid overloading the merchant. The scheduling module 204 further engages the delivery service entity, with pickup and delivery instructions. The scheduling module 204 notifies the delivery service entity to pick up an order, which is ready for pick up.

Alternatively or additionally, the scheduling module 204 enables the merchant to engage the delivery service entity, with pickup and delivery instructions. In all such cases, the scheduling module 204 is responsible to notify the concerned devices (i.e. sender device 102, merchant device 108 and recipient device 110) and ensure that the order is “complete”.

The application 202 allows the merchant to mark/tag the status of an order at various stages right from placing of order till delivery. As an example, application 202 allows the merchant to mark/tag an order as “ready for pick up” when the order is packed. The scheduling module 204 may send a notification to the delivery service entity device 112 to pick up the order when the merchant 105 has marked/tagged the order as “ready for pick up”. Further the application 202 allows the merchant to mark an order “picked-up” when the order is picked up by the delivery service entity. Furthermore, the application 202 allows the merchant to update status of an order during transit. The application 202 allows the merchant to mark/tag the order as “delivered” upon delivery to the recipient. The various statuses at various stages of the order right from placing of order till delivery are communicated to the sender device 102 and the recipient device 110.

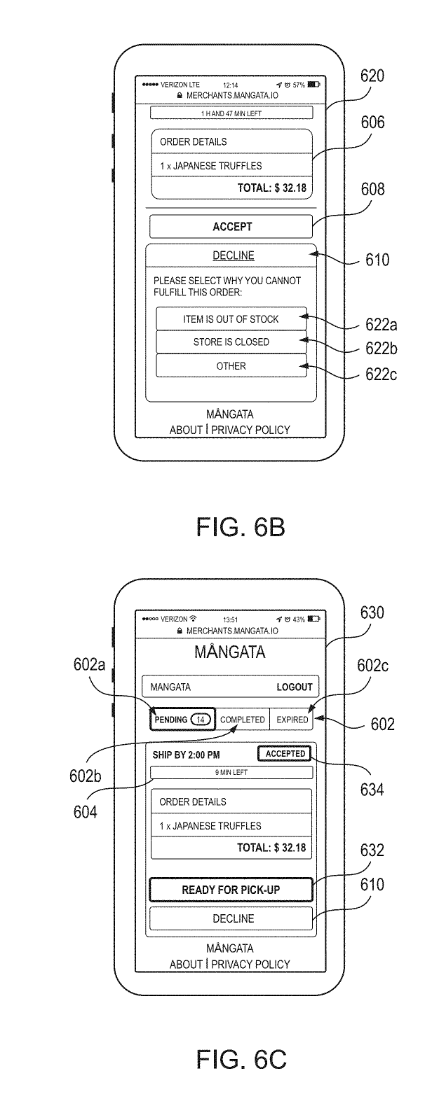

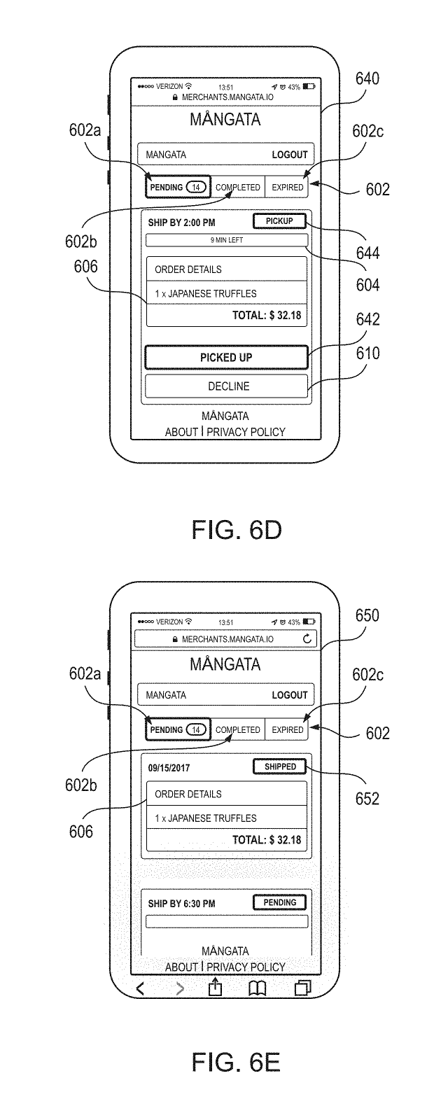

FIGS. 6A-6E are illustrations of user interfaces 600, 620, 630, 640 and 650 for facilitating a merchant device 108 to check due orders and complete due orders, in accordance with an example embodiment. It shall be noted that the user interfaces 600, 620, 630, 640 and 650 are interfaces displayed at a merchant device 108 when the server system 104 communicates with the merchant device 108. Further, the illustrations of the FIGS. 6A-6E are in support of the embodiment(s), where the merchant device 108 is equipped with the application 202 installed therein.

Referring to FIG. 6A, a user interface 600 displays an actionable icon 602, wherein the actionable icon 602 includes one or more actionable sub icons 602a, 602b and 602c. In this example, actionable icon 602 includes three actionable sub icons; however, the disclosure may not be limited to three actionable sub icons. The icon 602a displays pending orders. The icon 602b displays completed orders and the icon 602c displays expired orders. A text indicating a number (e.g. number of pending orders, number of completed orders etc.) may be provided at each icon 602a, 602b and 602c. Selecting an icon among the icons 602a, 602b and 602c may display a summary of the orders corresponding to the icons. As an example, selecting the icon 602a, may display a list of pending orders. The list may include as many orders as indicated by the number provided at the icon 602a. The list may be sorted based on the time remaining to complete the order, wherein the time remaining is calculated based on the time and date specified by the recipient 103 for delivering the order. The user interface 600 may display the time remaining for an order to be shipped (e.g. “2 hours remaining”, 1 hour and 47 minutes remaining” etc) at field 604. The user interface 600 may further display a time when the merchant should ship the order (e.g. Ship by 2:00 p.m.). An icon 612 indicating a status of the order is also displayed at the user interface 600. As an example, the user interface 600 displays the icon 612 which indicates that the order is “pending” for acceptance/approval by the merchant 105 or decline by the merchant 105. The user interface 600 further displays a summary of the order at a field 606, which includes the item description (e.g. “Japanese truffles”), item quantity (e.g. 1) and the total cost (e.g. 32.18). The user interface 600 further includes actionable icons 608 and 610. The actionable icon 608 displays a command “accept” selection which enables the merchant to prepare the order for delivery and engage delivery service entity for the delivery. The actionable icon 610 displays a command “decline” selection which enables the merchant to decline the order.

Referring to FIG. 6B, upon selection of the actionable icon 610 (“decline”), a user interface 620 displays one or more actionable icons 622a, 622b and 622c. It shall be noted that the disclosure may not be limited to three actionable icons 622a, 622b and 622c. The actionable icons 622a, 622b and 622c represent one or more reasons as to why the merchant has declined the order. As an example, the actionable icon 622a may include a reason “Item is out of stock”, the actionable icon 622b may include a reason “store is closed”, and the actionable icon 622c may include a reason “others”. The actionable icons 622a, 622b and 622c may be in form of a drop down menu. Upon selecting the actionable icon 610 and selecting a reason from the actionable icons 622a, 622b or 622c, the server system 104 sends notifications to the sender device 102 and the recipient device 110 about the “decline” of the order and the reason for “decline”.

Referring to FIG. 6C, upon selection of the actionable icon 608 (see, “accept” in FIG. 6B), a user interface 630 displays an actionable icons 632. The actionable icon 632 enables the merchant to tag or mark the item as “ready for pick-up”. Selection of the actionable icon 632 updates the status or the order and stores the information on the update at the server system 104. The scheduling module 204 of the server system 104 may communicate the status update to the sender device 102 and the recipient device 110. Alternatively, information on the status of the order may be communicated by the merchant device 108 to the sender device 102 and the recipient device 110. An icon 634 indicating a status of the order is also displayed at the user interface 630. As an example, the user interface 630 displays the icon 634 which indicates that the order is “accepted” by the merchant 105. It shall be noted that icon 634 resembles the icon 612 of the user interface 600 and both icons indicate the status of the order. In an embodiment, the icon 612 may be updated or changed to the icon 634 as a result of external trigger by the server system 104. As an example, the status of the order as indicated by the icon 612 may be updated to the status indicated by the icon 634 as a result of the merchant 105 accepting the order.

Referring to FIG. 6D, the application 202 may facilitate a user interface 640. The user interface 640 includes an actionable icon 642. The user interface 640 may be displayed at the merchant device 108 as a result of selecting the actionable icon 632 “ready for pick up” at the user interface 630. Alternatively or additionally, the user interface 640 may be triggered externally by the server system 104 when an executive of the delivery service entity has picked up the order. The actionable icon 642 enables the merchant to tag or mark the item as “picked up”. Selection of the actionable icon 642 updates the status or the order and stores the information about the update at the server system 104. The server system 104 may communicate the status update to the sender device 102 and the recipient device 110. Alternatively, information about the status of the order may be communicated by the merchant device 108 to the sender device 102 and the recipient device 110. An icon 644 indicating a status of the order is also displayed at the user interface 640. As an example, the user interface 640 displays the icon 644 which indicates that the order is “picked up” by a delivery executive representing a delivery service entity. In an embodiment, the icon 612 may be updated or changed to the icon 634 as a result of external trigger by the server system 104. Similarly, the icon 634 may be updated or changed to the icon 644 as a result of external trigger by the server system 104. As an example, the status of the order as indicated by the icon 634 may be updated to the status indicated by the icon 644 as a result of the delivery executive representing a delivery service entity 107 picking up the order.

FIG. 6E illustrates a user interface 650, where the merchant 105 receives information on when the order has been shipped to the recipient 103. Information regarding the shipping date and time may be received from the delivery service entity 107. Information regarding the shipping date and time may be communicated to the sender device 102 and the recipient device 110. An icon 652 indicating a status of the order is displayed at the user interface 650. As an example, the user interface 650 displays the icon 652 which indicates that the order is “shipped” by a delivery executive representing a delivery service entity. In an embodiment, the icon 644 may be updated or changed to the icon 652 as a result of external trigger by the server system 104. As an example, the status of the order as indicated by the icon 644 may be updated to the status indicated by the icon 652 as a result of the order being shipped through the delivery service entity 107.

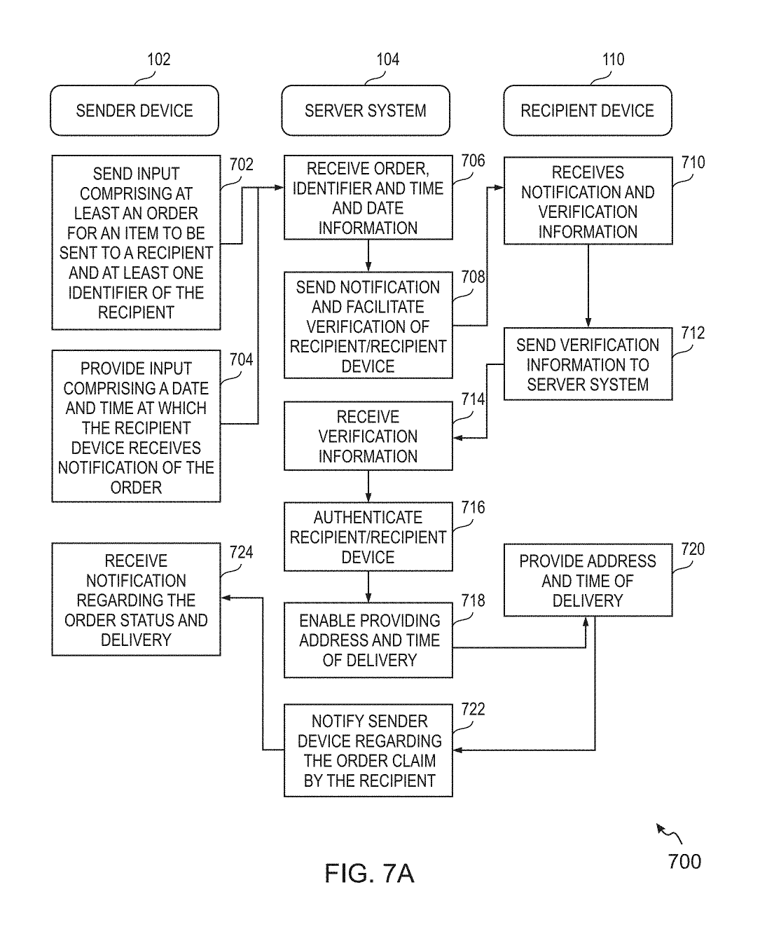

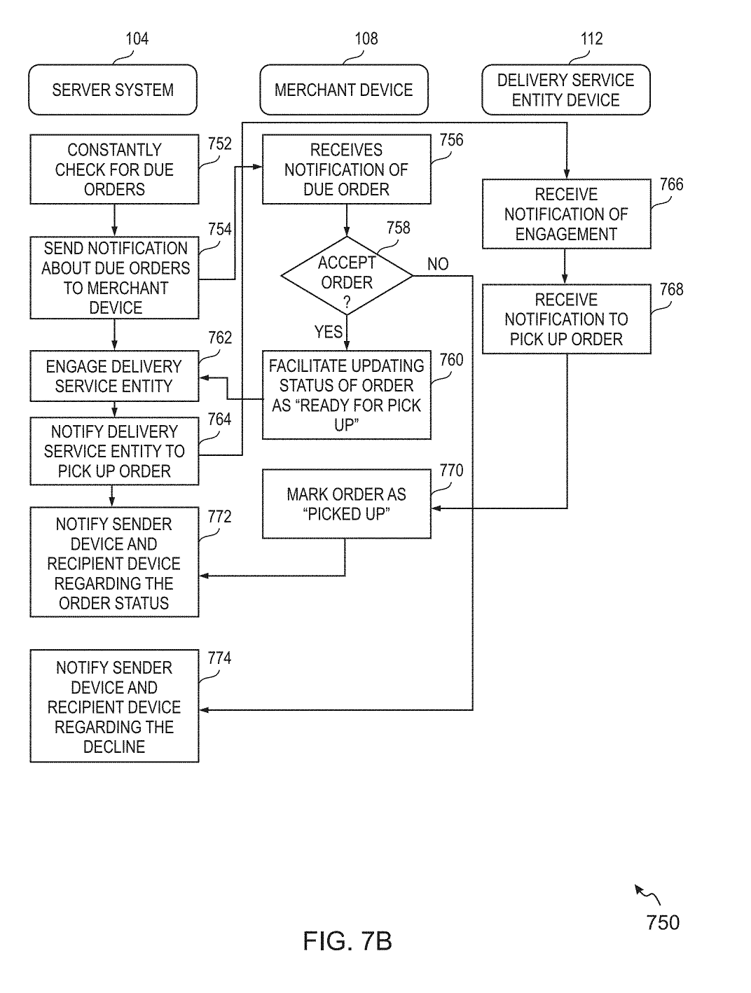

FIG. 7A is a flowchart 700 illustrating a workflow between the sender device 102, the server system 104 and the recipient device 110, for distributing on demand address-less goods, in accordance with an example embodiment. One or more operations of workflow are carried out at the sender device 102, one or more operations of workflow are carried out by the server system 104 and one or more operations of workflow are carried out at the recipient device 110. The sequence of operations of the workflow may not be necessarily executed in the same order as they are presented. Further, one or more operations may be grouped together and performed in form of a single step, or one operation may have several sub-steps that may be performed in parallel or in sequential manner.

At operation 702, the sender device 102 sends input comprising at least an order for an item to be sent to a recipient 103 and at least one identifier of the recipient 103. At operation 704, the sender device 102 provides input comprising a date and time at which the recipient device 110 receives notification of the order. The application 202 may facilitate the sender device 102 to provide a date and time at which the recipient 103 is to be notified regarding the order/gift. At operation 706, the server system 104 receives order, identifier of the recipient 103 and time and date information. At operation 708, the server system 104 sends notification to the recipient device 110 and facilitates verification of the recipient 103/recipient device 110. The notification is sent by the notification sending module 206 of the application 202. The notification may include a text message, a push message or an email. The notification includes an instruction as to how to claim the order. The notification may include a link that redirects the recipient 103 to steps to be followed in order to claim the order. At operation 710, the recipient device 110 receives the notification and verification information from the server system 104. Verification information may include an instruction to enter at least one identifier received from the sender device 102, by the recipient 103 correctly. Upon correctly entering the identifier, the server system 104 may further send an auto generated code to the recipient device 110. At operation 712, the recipient device 110, sends verification information to server system 104. The recipient device 110 communicates the auto generated code to the server system 104. At operation 714, the server system 104, receives verification information from the recipient device 110. At operation 716, the server system 104, authenticates recipient 103/recipient device 110 if the verification information received from the recipient device 110 is correct. Upon receiving the correct code, the server system 104 may authenticate the recipient 103/recipient device 110. At operation 718, the server system 104, enables the recipient device 110 to provide an address and time and date of order delivery. At operation 720, the recipient device 110, provides the address and time of delivery. At this stage, the notification sending module 206 may notify the sender device 102 that the recipient has claimed the order/gift. At operation 722, the server system 104 sends notification to the sender device 102 regarding the order claim by the recipient 103. At operation 724, the sender device 102 receives notification of order claim by the recipient 103.

Alternatively or additionally, the server system 104 may provide option (not shown) at the recipient device 110 to decline the order by the recipient 103. The option may include an actionable icon or a link that enables the recipient 103 to decline the order. When the recipient selects the option to decline the order, the notification sending module 206 may send notification to the sender 101 at the sender device 102.

Simultaneously, the server system 104 may notify the merchant device 108 of the order and due delivery of the order. The scheduling module 204 of the server system 104 constantly checks due orders and due delivery to be notified to the merchant 105. Further, the scheduling module 204 engages the delivery service entity 107 to pick up order and deliver order on a specified date to the recipient 103.

FIG. 7B is a flowchart 750 illustrating a workflow between the server system 104, the merchant device 108 and the delivery service entity device 112 for distributing on demand address-less goods, in accordance with an example embodiment. One or more operations of workflow is carried out by the server 104, one or more operations of workflow is carried out by the merchant device 108 and one or more operations of workflow is carried out by the delivery service entity device 112. The workflow includes a sequence of steps or operations. The sequence of operations of workflow may not be necessarily executed in the same order as they are presented. Further, one or more operations may be grouped together and performed in form of a single step, or one operation may have several sub-steps that may be performed in parallel or in sequential manner by the application 202 present in the server 104.

At operation 752, the server system 104 constantly check for due orders. At operation 754, the server system 104 sends notification about due orders to the merchant device 108. The merchant device 108 receives notification of due order at operation 756. At operation 758, it is determined if the merchant 105 has accepted or declined the order. If it is determined that the merchant 105 has accepted the order, the server system 104 facilitates the merchant device 108 to update the order as “ready for pick up”, at operation 760. It shall be noted that the merchant 105 marks the order as “ready for pick up” only upon preparing and/or packing the order. Once the merchant 105 has marked the order as “ready for pick up”, the server system 104 notifies the delivery service entity 107 to pick up the order. Further at operation 762, the server system 104 engages the delivery service entity 107 to deliver the order to the recipient. Further at operation 764, the server system 104 notifies the delivery service entity 107 to pick up the order. At operation 766, the delivery service entity 107 receives notification to pick up the order. At operation 768, the delivery service entity 107 engages a delivery service executive to pick up the order, using the delivery service entity device 112. At operation 770, the server system 104 facilitates the merchant device 108 to update the status of the order as “picked up”. Once the merchant 105 has marked the order as “picked up” at operation 770, the server system 104 notifies sender device 102 and recipient device 110 regarding the order status indicating that the order has been picked up.

If at operation 758, it is determined that the merchant 105 has not accepted the order or the merchant 105 has declined the order, then at operation 774 the server system 104 notifies the sender 101 and the recipient 103 regarding the decline, at their respective devices 102 and 110.

The workflows (e.g., defined by flowcharts 700 and 750 as illustrated in FIGS. 7A and 7B) represent operations that are pro-active and trigger based (real time). The trigger-based operations entail a step in the workflow executing immediately upon the onset of an operation (for instance, a push notification is triggered to the sender 101 as soon as the recipient claims the gift). In other words, operations that require an external trigger, such as press of a button facilitated by the application 202 or a web browser representing the application 202, are trigger based operations. The pro-active operations are those operations in the workflow that requires various conditions to be met or that take place upon meeting some conditions, including time. For instance, the notification sent to the recipient 103, not before or after, but at the scheduled time. Another example would be the merchant 105 receiving the order and the notification corresponding to it at an appropriate time, rather than as soon as the order is placed. This prevents the merchant 105 getting an order two weeks prior to its due, while it takes only 20 minutes to prepare. Further, the triggers are activated upon button presses and the subsequent completion of the process associated with that press.

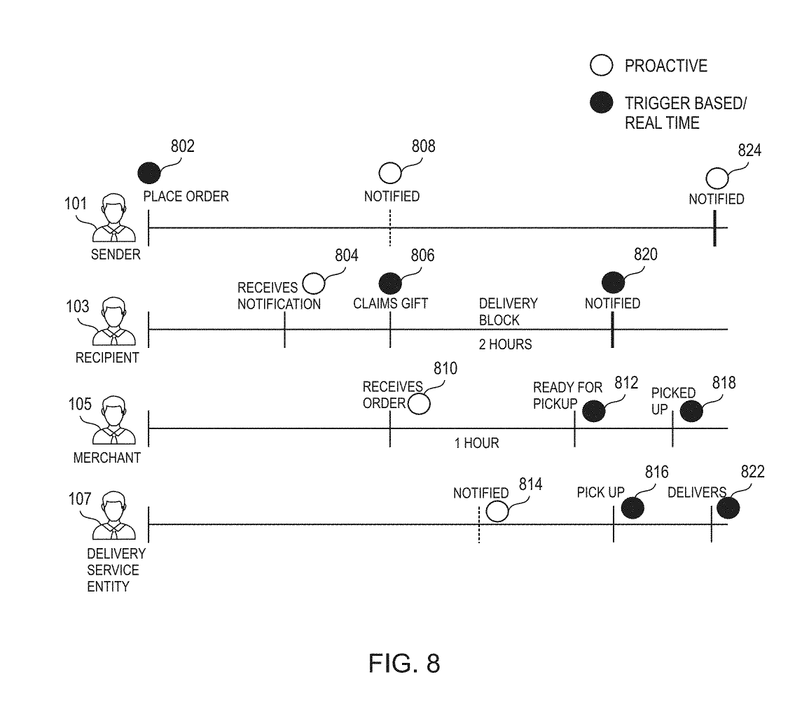

FIG. 8 is a schematic representation of the workflow between the sender 101, the receiver 103, the merchant 105 and the delivery service entity 107, in accordance with an example embodiment. The schematic representation of the workflow also illustrates the proactive and trigger based operation in the workflow. The sequence of operations of workflow may not be necessarily executed in the same order as they are presented. Further, one or more operations may be grouped together and performed in form of a single step, or one operation may have several sub-steps that may be performed in parallel or in sequential manner by the application 202 present in the server 104.

At operation 802, the sender 101 places the order and provides identifiers associated with the recipient 103. The operation 802 is a trigger based operation. The sender 101 then checks out in the application 202. Upon a successful order placement, the scheduling module 204 is triggered to schedule the order. At operation 804, the recipient 103 receives notification regarding the order, which is a proactive operation. Subsequently the recipient 103 triggers an operation 806 by pressing a button (actionable icon) facilitated by the application 202 or a web browser representing application 202 that indicates “claiming” the order. Claiming the order includes, verification of the identifiers of the recipient 103 and providing address and date and time of delivery of the order. The scheduling module 204 may assign a delivery block (say 2 hours) until the recipient 103 receives a notification on status of the order. Upon completion of the operation 806, the scheduling module 204 pushes an immediate notification to the sender 101 at operation 808. Operation 808 is triggered upon the receipt of the notification by the recipient 103 at 804.

At operation 810 merchant 105 receives a notification about the order (proactive operation). The merchant 105 prepares the order and, at operation 812, presses a button facilitated by the application 202 or a web browser representing application 202 to update status of the order. As an example, the status of the order may be ‘ready for pickup’. At operation 814, the delivery service entity 107 is notified of the status of the order and receives instructions to pick up the order. At operation 816, the delivery service entity 107 picks up the order. At operation 818, the merchant 105 presses a button facilitated by the application 202 or a web browser representing the application 202 to update status of the order. As an example, the status of the order may be “picked up”. At operation 820, the recipient 103 is notified about the status of the order. The delivery service entity 107 delivers the order to the recipient 103, at operation 822 at a time and address provided by the recipient 103 (at operation 806). The notification sending module 206 sends a notification to the sender 101, at operation 824, to inform the sender 101 about the successful delivery of the order.

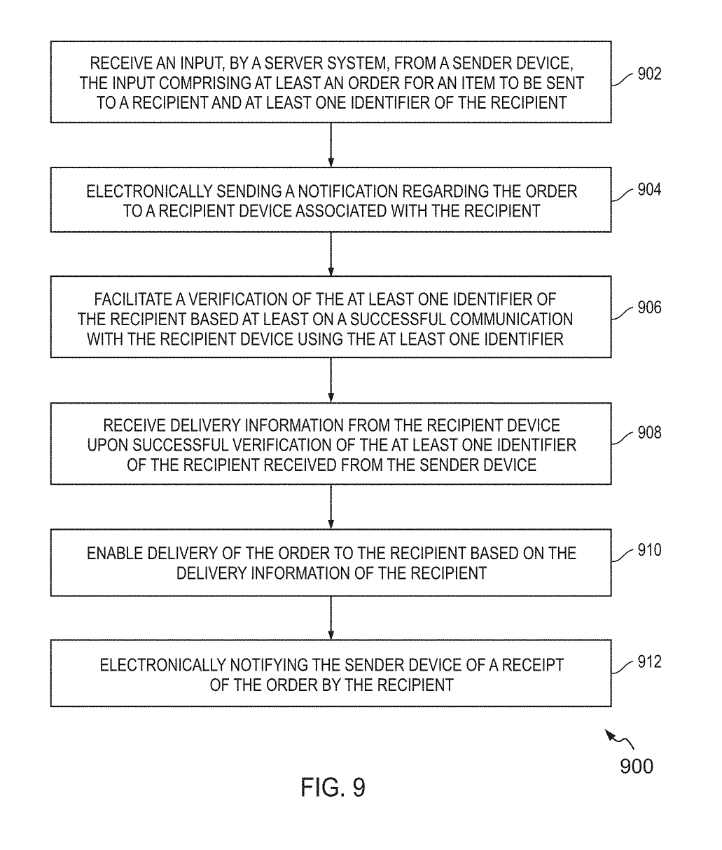

FIG. 9 is a flowchart illustrating a method 900 of distributing on demand address-less goods, in accordance with an example embodiment. The method 900 is carried out by the server 104 and includes a sequence of steps or operations. The sequence of operations of the method 900 may not be necessarily executed in the same order as they are presented. Further, one or more steps may be grouped together and performed in form of a single step, or one step may have several sub-steps that may be performed in parallel or in sequential manner by application 202 present in the server 104.

At operation 902, the server system 104 receives an input, from the sender device 102. The input comprises at least an order for an item to be sent to a recipient and at least one identifier of the recipient. Typically, the sender uses the application 202 to order the item. The recipient is selected from the contacts list on the sender's phone. The identifier may include a name, a phone number or an email address associated with the recipient. The input may further comprise a data and time at which the notification regarding the order may be sent to the recipient device 110. Once the order is placed as seen in FIGS. 4A-4C, the sender checks out of the application 202.

At operation 904, the server system 104 electronically sends a notification regarding the order to the recipient device 110 associated with the recipient selected from a sender's contact list. The notification, as an example, may be a text message, a push message or an email. It shall be noted that, in some cases, the recipient devices 110 may not have the application 202 installed therein. In such cases, the notification may be received in the form of a text message or an email. Otherwise, the notification can be sent to the application 202 installed in the recipient device 110, which can thereafter notify the recipient 105 in form of a pop-up message.

At operation 906, the server system 104 facilitates a verification of the at least one identifier of the recipient based on at least successful communication with the recipient device 110. As an example, the recipient device 110 may be instructed to input the phone number as a first step of verification. Upon receiving the phone number, the server system 104 may further instruct the recipient device 110 to input an auto generated authentication code, such as an “OTP” or a “PIN” sent by the server system 104. Upon successfully verifying the phone number, the recipient device 110 may be authenticated by the server system 104.

At operation 908, the server system 104 receives delivery information of the recipient from the recipient device 110 upon successful verification of the at least one identifier of the recipient received from the sender device 102. Delivery information includes a shipping address, delivery instructions and date and time for the delivery. Shipping address may be provided through a suitable third-party auto complete service.

At operation 910, the server system 104 enables delivery of the order to the recipient 103 based on the delivery information of the recipient 103. The server system 104 further checks one or more due orders for delivery. The scheduling module 204 typically checks periodically for any due orders for merchants. The server system 104 notifies, the merchant device 108 to take appropriate actions thereby ensuring that the order is complete, upon receiving the delivery information from the recipient device 110. A text message is also sent to the merchant device 108 along with instructions on how to view the order(s). The merchant may accept the orders or reject the order. If the merchant accepts the orders, then the merchant prepares the order, finishes the order and marks the order as “ready for pick-up”. Alternatively, if the merchants reject the order then, the server system 104 may notify the sender device 102 and/or the recipient device 110 of the same. The server system 104 engages a delivery service entity to ensure that the due order is delivered. An executive representing the delivery service entity picks up the order and the merchant marks the order as “picked-up”. The recipient is notified that the order is on its way. The executive delivers the order.

At operation 912, the server system 104 subsequently notifies the sender 101 regarding receipt of the order by the recipient. The notification may be sent as a text message, an email or a push notification to the sender device 102.

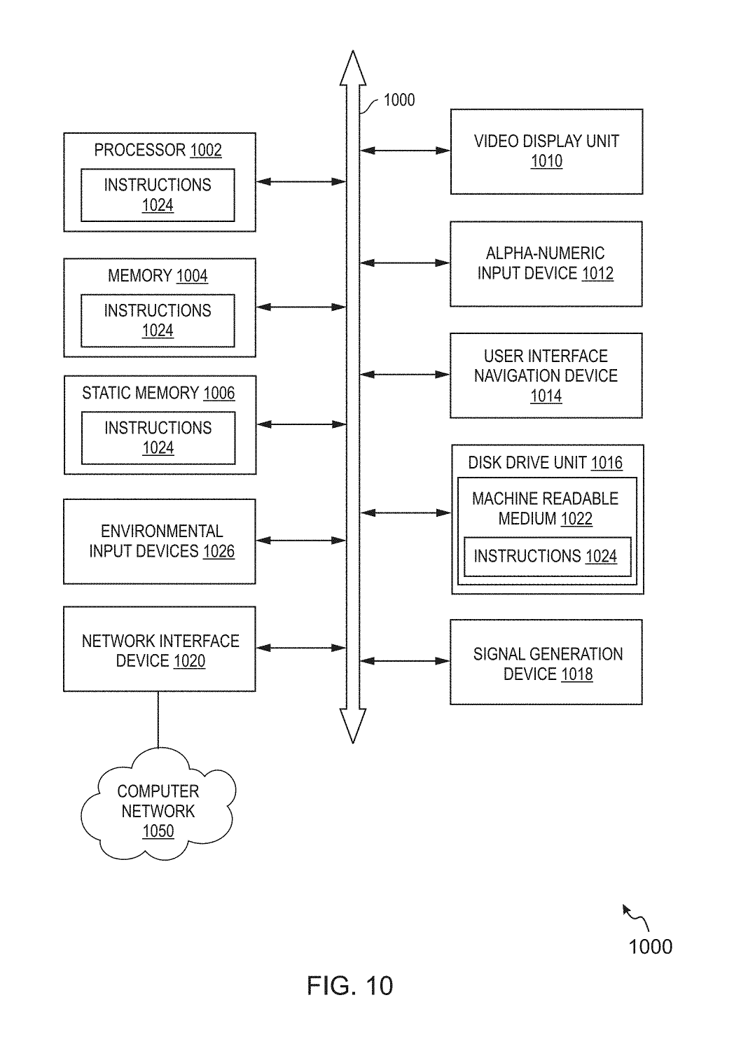

FIG. 10 is a simplified block diagram of a device 1000 which may be an example of the sender device 102, the recipient device 110, the merchant device 108 and the delivery service entity device 112. Instructions within the device 1000, causes the device 1000 to perform any one or more of the methods discussed herein. In alternative embodiments, the device 1000 operates as a standalone device or may be connected (e.g., networked) to other devices. In a networked deployment, the device 1000 may operate in the capacity of a server or a client device in a server-client network environment, or as a peer machine in a peer-to-peer (or distributed) network environment. The device 1000 may be any device capable of executing instructions (sequential or otherwise) that specify actions to be taken by the device 1000. Further, while only a single device is illustrated, the term “device” shall also be taken to include any collection of devices that individually or jointly execute a set (or multiple sets) of instructions to perform any one or more of the methods discussed herein.

The device 1000 includes a processor 1002 (e.g., a central processing unit (CPU), a graphics processing unit (GPU), or both), a main memory 1004, and a static memory 1006, which communicate with each other via a bus 1008. The device 1000 may further include a video display unit 1010 (e.g., a liquid crystal display (LCD) or a cathode ray tube (CRT)). The device 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020. The device 1000 may also include a environmental input device 1026 that may provide a number of inputs describing the environment in which the device 1000 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

The disk drive unit 1016 includes a machine-readable medium 1022 storing one or more sets of data structures and instructions 1024 (e.g., software) embodying or utilized by any one or more of the methodologies or functions described herein. The instructions may be computer executable codes of the application 202 for distributing items to recipients. The instructions 1024 may also reside, completely or at least partially, within the main memory 1004 and/or within the processor 1002 during execution thereof by the device 1000, the main memory 1004 and the processor 1002 also constituting machine-readable media. While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 1024 may further be transmitted or received over a computer network 1050 using a transmission medium. The instructions 1024 may be transmitted using the network interface device 1020 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise Java Beans. Much functionality described herein can be implemented in computer software, computer hardware, or a combination. Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 902.11 including its sub standards a, b, e, g, h, i, n, et al.). In one example, signals from the device 1000 can be transferred, at least in part, wirelessly to components or other computers.

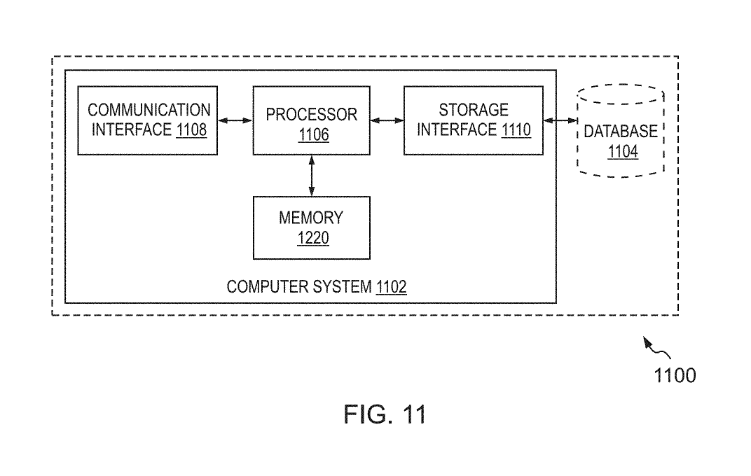

FIG. 11 is a simplified block diagram of a server system 1100, in accordance with one embodiment of the present disclosure. The server system 1100 is an example of a server system 104 that is a part of the system 100. The server system 1100 includes computer system 1102 and database 1104.

The computer system 1102 includes a processor 1106 for executing instructions. Instructions may be stored in, for example, but not limited to, a memory 1108. The processor 1106 may include one or more processing units (e.g., in a multi-core configuration). The processor 1106 is operatively coupled to a communication interface 1108 such that computer system 1102 is capable of communicating with a remote device such as the sender device 102 (shown in FIG. 1)

The processor 1106 may also be operatively coupled to the database 1104. The database 1104 is any computer-operated hardware suitable for storing and/or retrieving data. The database 1104 may include multiple storage units such as hard disks and/or solid-state disks in a redundant array of inexpensive disks (RAID) configuration. The database 1104 may include a storage area network (SAN) and/or a network attached storage (NAS) system.

In some embodiments, the database 1104 is integrated within computer system 1102. For example, computer system 1102 may include one or more hard disk drives as database 1104. In other embodiments, database 1104 is external to computer system 1102 and may be accessed by the computer system 1102 using a storage interface 1110. The storage interface 1110 is any component capable of providing the processor 1106 with access to the database 1104. The storage interface 1110 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1106 with access to the database 1104.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 1100 and its various components such as the computer system 1102 and the database 1104 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 11. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application \or implementation without departing from the spirit or scope of the claims.

What is claimed is:

1. A method for distributing on-demand items, the method comprising:
receiving an input, by a server system, from a sender device, the input comprising at least an order for an item to be sent to a recipient and at least one identifier of the recipient;
electronically sending, by the server system, a notification regarding the order to a recipient device associated with the recipient;
facilitating a verification of the at least one identifier of the recipient based at least on a successful communication with the recipient device using the at least one identifier;
receiving delivery information from the recipient device upon successful verification of the at least one identifier of the recipient received from the sender device;
enabling delivery of the order to the recipient based on the delivery information of the recipient; and
electronically notifying the sender device of a receipt of the order by the recipient.

2. The method as claimed in claim 1, wherein enabling delivery of the order to the recipient further comprises:
electronically notifying a merchant device associated with a merchant to complete the order; and
facilitating the merchant to engage a delivery service entity to deliver the order to the recipient.

3. The method as claimed in claim 2 further comprising enabling the merchant device to perform one of:
accepting the order to prepare for the delivery; and
declining the order.

4. The method as claimed in claim 3, further comprising enabling the merchant device to update a status of the order upon accepting the order, the status being one of a ready for pick up status and a picked up status.

5. The method as claimed in claim 3, further comprising electronically notifying the sender device and the recipient device of the decline of the order by the merchant device.

6. The method as claimed in claim 2, wherein engaging the delivery service entity further comprises notifying a delivery service entity device associated with the delivery service entity, to pick up the order from a merchant location.

7. The method as claimed in claim 6, wherein engaging the delivery service entity comprises providing delivery instructions associated with the order.

8. The method as claimed in claim 1, wherein receiving the at least one identifier from the sender device comprises receiving one or more of a name, an email address and a phone number of the recipient.

9. The method as claimed in claim 1, wherein electronically sending the notification to the recipient device comprises sending the notification to the recipient device at a time and date provided by the sender.

10. The method as claimed in claim 1, wherein receiving delivery information from the recipient device comprises one or more of:
receiving a shipping address associated with the recipient;
receiving a date and time of delivery of the order preferred by the recipient; and
receiving instructions regarding delivery of the order.

11. The method as claimed in claim 1, wherein facilitating verification of the at least one identifier further comprises:
sending instructions to the recipient device to verify the at least one identifier of the recipient received from the sender device, the identifier including at least one of a phone number and an email address of the recipient;
sending an auto generated code to the at least one identifier of the recipient; and
receiving the auto generated code from the at least one identifier of the recipient.

12. The method as claimed in claim 1, further comprising notifying the recipient of status of the delivery on the recipient device.

13. The method as claimed in claim 1, wherein electronically notifying the sender device regarding the receipt of the order comprises notifying through at least one of a push notification and an email notification.

14. A server system for distributing on-demand items to a recipient, the server system comprising:
a memory storing instructions; and
at least one processor configured to execute the stored instructions to cause the server system to at least perform:
receiving an input from a sender device, the input comprising at least an order for an item to be sent to a recipient and at least one identifier of the recipient;
electronically sending a notification regarding the order to a recipient device associated with the recipient;
facilitating a verification of the at least one identifier of the recipient based at least on a successful communication with the recipient device using the at least one identifier;
receiving delivery information from the recipient device upon successful verification of the at least one identifier of the recipient received from the sender device;
enabling delivery of the order to the recipient based on the delivery information of the recipient; and
electronically notifying the sender device of a receipt of the order by the recipient.

15. The system as claimed in claim 14, wherein the server system comprises a scheduling module configured to enable delivery of the order by:
electronically notifying a merchant device associated with a merchant to complete the order; and
facilitating the merchant to engage a delivery service entity to deliver the order to the recipient.

16. The system as claimed in claim 14, wherein the at least one identifier comprises one or more of a name, an email address and a phone number of the recipient.

17. The system as claimed in claim 14, wherein the server system comprises a notification sending module configured to electronically send the notification to the recipient device on a time and date provided by the sender.

18. The system as claimed in claim 16, wherein the server system is caused to perform verification of the at least one identifier by:
sending instructions to the recipient device to verify the at least one identifier of the recipient received from the sender device, the identifier including at least one of a phone number and an email address of the recipient;
sending an auto generated code to the at least one identifier of the recipient; and
receiving the auto generated code from the at least one identifier of the recipient.

19. A computer program product comprising at least one computer-readable storage medium, the computer-readable storage medium comprising a set of instructions, which, when executed by one or more processors of a server system, cause the server system to at least perform:
receiving an input from a sender device, the input comprising at least an order for an item to be sent to a recipient and at least one identifier of the recipient;
electronically sending a notification regarding the order to a recipient device associated with the recipient;
facilitating a verification of the at least one identifier of the recipient based at least on a successful communication with the recipient device using the at least one identifier;
receiving delivery information from the recipient device upon successful verification of the at least one identifier of the recipient received from the sender device;
enabling delivery of the order to the recipient based on the delivery information of the recipient; and
electronically notifying the sender device of a receipt of the order by the recipient.

20. The computer program product as claimed in claim 19, wherein the at least one identifier comprises one or more of a name, an email address and a phone number of the recipient.
